(19) United States
(12) Patent Application Publication
(10) Pub. No.: US 2009/0184588 A1
(43) Pub. Date: Jul. 23, 2009

(54) Switchgear for Protecting Dangerous Machines

(75) Inventors: Ralph-Rainer Jurgeit, Ahrensfelde (DE); Oliver Schrank, Berlin (DE); Olaf Anselm, Berlin (DE)

Correspondence Address: COHEN, PONTANI, LIEBERMAN & PAVANE LLP, 551 FIFTH AVENUE, SUITE 1210, NEW YORK, NY, 10176, US

(73) Assignee: PEPPERL + FUCHS GMBH, Berlin (DE)

(21) Appl. No.: 12/224,649

(22) PCT Filed: Feb. 28, 2007
(86) PCT No.: PCT/DE2007/000407

§ 371 Date: Dec. 9, 2008

(30) Foreign Application Priority Data
Feb. 28, 2006 (DE) 202006003477.3

(51) Int. Cl. H01H 9/00; H02H 11/00

(52) U.S. Cl. 307/326; 307/113

(57) ABSTRACT

A modular switchgear includes a connecting device having a plurality of positions; a plurality of output modules coupled to the connecting device, each of the output modules having a switching device, the switching device configured to set a number representing a position on the connecting device; and a plurality of input modules coupled to the connecting device, each input module having a position on the connecting device; wherein each input module is associated with the output module having its position set on a specific output module and ending with the next higher designated position set on a different output module minus 1.

The invention pertains to a modular switchgear containing a first output module, additional output modules, input modules, and a device for connecting the modules mentioned electrically together.

Safety switchgears evaluate the signals of safety sensors in a manner protected against failure and actuate the actuators assigned to them. These safety switchgears can be of modular design, where the modules are connected to each other by way of slots in a connecting device. These modular units can contain input modules, to which the safety sensors are connected, and output modules, which control or contain the actuators. The input modules can be assigned to the output modules in different ways. The patent DE 100 20 075 C, for example, describes an arrangement in which the input modules are assigned to the output modules on the basis of their physical position within the connecting device.

The present invention is based on the object of describing a simple and low-cost way of assigning input modules to output modules.

The object is achieved according to the invention in that the modular switchgear contains a first output module, additional output modules, input modules, and a connecting device, where each of the above-mentioned additional output modules is equipped with a switching device for setting a number representing a position on the connecting device of the switchgear, where all of the input modules starting with the position set on a specific output module and ending with next higher position set on a different output module minus 1 are assigned to that specific output module, the same method being applied to each of the output modules, where all the input modules starting from the highest set position on an output module and ending with the last position are assigned to the output module with that highest set position.

The core idea of the invention consists in that the assignment of the input modules to the output modules is determined not by their physical position but rather by the positions of the switches on the output modules.

The invention is explained in greater detail below on the basis of an exemplary embodiment with reference to the drawing.

The slot locations, which are essentially identical, are numbered in sequence, ascending from 1. The output modules are located in positions 1 to 3, and the input modules are located in positions 4 to 11. The switching devices of the output modules in positions 1, 2, and 3 are set to 4, 6, and 9, respectively. As a result of these settings, the input modules in positions 4 and 5 act on the output module in position 1, the input modules in positions 6, 7, and 8 act on the output module in position 2, and the input modules in positions 9, 10, and 11 act on the output module in position 3.

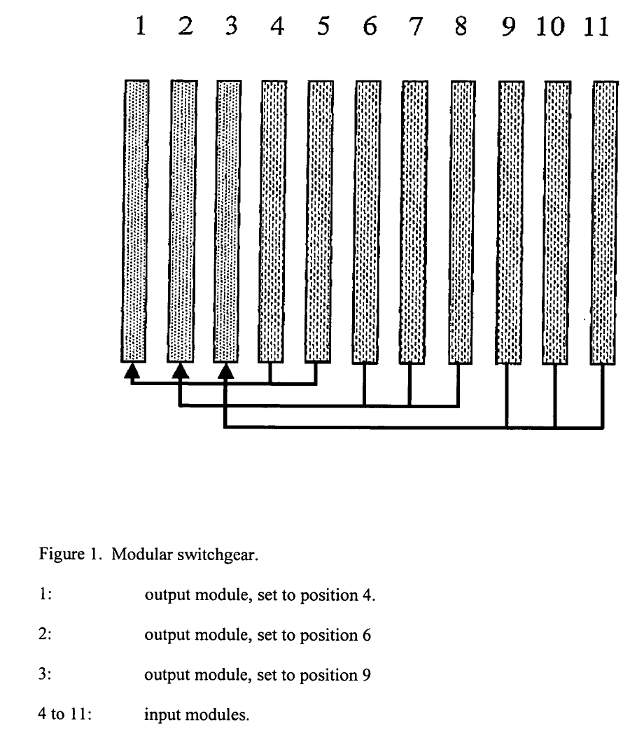

FIG. 1. Modular switchgear.
1: output module, set to position 4.
2: output module, set to position 6
3: output module, set to position 9
4 to 11: input modules.

1-2. (canceled)

3. A modular switchgear comprising:
a connecting device having a plurality of positions;
a plurality of output modules coupled to the connecting device, at least one of the output modules having a switching device, the switching device configured to be set with a number representing a position on the connecting device; and
a plurality of input modules coupled to the connecting device, each input module having a position on the connecting device; wherein
each input module is associated with the output module having its position set on a specific output module and ending with a next higher position set on a different output module minus 1.

4. The modular switchgear according to claim 3, wherein the input modules starting from the highest set position on an output module and ending with a last position are assigned to the output module with a highest set position.

5. The modular switchgear according to claim 3, wherein the connecting device has at least 11 designated positions.

6. The modular switchgear according to claim 5, wherein the output modules are at positions 1, 2, and 3.

7. The modular switchgear according to claim 6, wherein the input modules are at positions 4 through 11.

8. The modular switchgear according to claim 7, wherein the output module at position 1 has its switching device set to position 4;
the output module at position 2 has its switching device set to position 6; and
the output module at position 2 has its switching device set to position 9.

9. The modular switchgear according to claim 8, wherein
the input modules at locations 4 and 5 are associated with the output module at position 1;
the input modules at locations 6, 7, and 8 are associated with the output module at position 2; and
the input modules at locations 9, 10, and 11 are associated with the output module at position 3.

10. The modular switchgear according to claim 7, wherein the output module at position 1 has its switching device set to position 4;
the output module at position 2 has its switching device set to position 7; and
the output module at position 2 has its switching device set to position 10.

11. The modular switchgear according to claim 10, wherein
the input modules at locations 4, 5, and 6 are associated with the output module at position 1;
the input modules at locations 7, 8, and 9 are associated with the output module at position 2; and
the input modules at locations 10 and 11 are associated with the output module at position 3.

12. The modular switchgear according to claim 5, wherein
the output modules are at positions 1, and 2;
the input modules are at positions 3 through 11;
the output module at position 1 has its switching device set to position 3; and
the output module at position 2 has its switching device set to position 8.

13. The modular switchgear according to claim 12, wherein
the input modules at locations 3 through 7 are associated with the output module at position 1; and
the input modules at locations 8 through 11 are associated with the output module at position 2.

14. The modular switchgear according to claim 4, further comprising at least one additional module.

15. The modular switchgear according to claim 14, wherein the at least one additional module is associated with one of the output modules based in part on the setting of the switching device.

16. The modular switchgear according to claim 14, wherein the at least one additional module is associated with one of the output modules independent of the setting of the switching device.

17. The modular switchgear according to claim 4, wherein the positions on the connecting device are sequential.

18. A modular switchgear comprising:
a connecting device having a plurality of positions;
a plurality of output modules coupled to the connecting device, each of the output modules having a switching device, the switching device configured to be set with a position on the connecting device; and
a plurality of input modules coupled to the connecting device, each input module having a position on the connecting device; wherein
each input module is associated with the output module having its position set on a specific output module and ending with the next higher position set on a different output module minus 1.

19. The modular switchgear according to claim 18, wherein the input modules starting from the highest set position on an output module and ending with the last position are assigned to the output module with that highest set position.

20. The modular switchgear according to claim 19, wherein the positions on the connecting device are sequential.

21. The modular switchgear according to claim 20, wherein the connecting device has at least 11 designated positions;
the output modules are at positions 1, 2, and 3;
the input modules are at positions 3 through 11;
the output module at position 1 has its switching device set to position 4;
the output module at position 2 has its switching device set to position 6; and
the output module at position 3 has its switching device set to position 9.

22. The modular switchgear according to claim 21, wherein
the input modules at locations 4 and 5 are associated with the output module at position 1;
the input modules at locations 6, 7, and 8 are associated with the output module at position 2; and
the input modules at locations 7, 8, 9, 10, and 11 are associated with the output module at position 3.
